(19) United States
(12) Patent Application Publication
(10) Pub. No.: US 2002/0025354 A1
(43) Pub. Date: Feb. 28, 2002

(54) Reduced mass unitary cartridges with internal intensification for ultra high-pressure high-temperature press apparatus

(76) Inventor: David R. Hall, Provo, UT (US)

Correspondence Address: David R. Hall, 2185 S Larsen Pkwy, Provo, UT, 84606, US

(21) Appl. No.: 09/961,770

(22) Filed: Sep. 21, 2001

Related U.S. Application Data
(63) Continuation-in-part of application No. 09/482,065, filed on Jan. 13, 2000, now abandoned.
Application No. 09/482,065 is a division of application No. 09/037,507, filed on Mar. 10, 1998, now abandoned.

(51) Int. Cl. B30B 1/32

(52) U.S. Cl. 425/174.6; 425/469; 92/135

(57) ABSTRACT

A reduced mass unitary cartridge with internal fluid intensification for an ultra-high pressure, high-temperature, fluid driven press apparatus capable of reaching pressures in excess of 35 kilobars and temperatures above 1000 degrees centigrade, useful in the production of such high-pressure products as diamond, polycrystalline diamond, cubic boron nitride, and like superhard materials.

### CROSS-REFERENCES TO RELATED APPLICATIONS

Continuation in Part of application Ser. No. 09/482,065, a Divisional application of U.S. application Ser. No. 09/037,507, Filed Mar. 10, 1998

### BACKGROUND OF THE INVENTION

This invention relates to a unitary frame and fluid driven unitary cartridges useful in an ultra high-pressure, high-temperature, press apparatus. More particularly, this invention relates to a reduced mass, multi-axis, ultra-high pressure, high temperature, hydraulically actuated, press apparatus capable of reaching pressures in excess of 35 kilobars and temperatures above 1000 degrees centigrade. Such a press is useful in the production and sintering of superhard materials such as cemented ceramics, diamond, polycrystalline diamond, cubic boron nitride, and exotic metallodial gases such as metallic hydrogen.

Multi-axis, ultra high-pressure, high-temperature, presses have been known in the art for the production and sintering of superhard materials for more than three decades. They may be classified by the tonnage of pressure, or “thrust,” they are capable of exerting on the reaction cell. For example, a 2000-ton multi-axis press is capable of producing a superhard payload in a two-inch cubic cell. FIG. 18 depicts a conventional multi-axis press that was patented by Dr. H. Tracy Hall, the inventor of reproducible man-made diamond. See U.S. Pat. Nos. 2,918,699 and 3,913,280. Basically, there are five components in this press design: the tie-bar frame (44), the massive bases (45) supporting the tie-bar frame, the piston cylinders (46), the guide pins (47), and the anvils (48). Since man-made diamond was first produced in a G.E.laboratory by Dr. Hall, circa 1953, the commercial production, and sintering of diamond and other superhard materials has become a multi-billion dollar industry worldwide. Modern production of superhard materials continues to increase at a growth rate of 15 percent, or more, annually. But despite the success of the superhard industry, given their unique properties, diamond and other superhard materials have barely scratched the surface of their potential commercial applications. In order for superhard materials to reach their full commercial potential, more economical and more efficient multi-axis presses must be designed and constructed to satisfy the ever increasing demand for these modern miracle materials.

Typically, the manufacturing or sintering process for superhard materials in a multi-axis press consists of placing a superhard payload inside a high-pressure, high-temperature, reaction cell known in the art. The reaction cell, made up of a pressure-transferring medium also known in the art, is placed within the press's high-pressure chamber and subjected to an ultra-high compressive force. During the press cycle, the pressure inside the cell must reach 35 kilobars, or more. Simultaneously, an electrical current is passed through the cell's resistance heating mechanism, also known in the art, raising the temperature inside the cell to above 1000° C. Once the superhard payload is subjected to sufficient pressure and temperature for a prescribed period of time, the current is terminated and the cell cooled. Pressure on the cell is then released, the anvils retracted, and the cell with its superhard payload removed from the press. The four aspects, then, of the multi-axis press cycle are: 1) to exert sufficient force on the cell, creating internal pressures above 35 kilobars, 2) to raise the temperature inside the cell to above 1000° C., 3) to cool the cell quickly; and 4) to release the force on the cell and retrieve the payload from the press.

The cost of construction of a multi-axis press is proportional to its mass and while its efficiency is proportional to the duration of its cycle and the volume of its payload. Therefore, the smaller the mass of the press, and the shorter the duration of the pressing cycle, and the larger the cell, permitting a larger volume of payload, the higher the economy and efficiency of the multi-axis press. These parameters presented significant engineering and design challenges to the inventor herein in reaching his objective of producing or sintering superhard materials more efficiently and more economically in a multi-axis press.

The inventor's first objective in making the press more efficient was to come up with a more compact press frame design. His aim was a press with less mass. One that would not exhibit the inertial bending moments of the tie-bar frame, which limited the size of the press and its payload capacity.

Intuitively for the design, the inventor settled upon a unique single-piece frame, which eliminated the tie bars, centralized the frame's mass, and permitted the use of internally intensified, unitary, piston cylinders. Surprisingly, he discovered that by using this unitary frame and cylinder design, he was able to achieve a significant reduction in the overall size and weight of the press. This made the press more economical to build and reduced the cost of payload produced per ton of press

Next, by using an innovative internal intensifier piston within a unitary cylinder, the inventor discovered that he could reduce even more the overall size and cost of the press. In the conventional tie-bar press system, the length and diameter of the piston cylinders are proportional to the overall size of the press, and the hydraulic fluid must be pumped to the press at pressures around 10,000 psi. or more, which requires specially made high-pressure pumps, hoses, and fittings. In the press of the present invention, on the other hand, the length and diameter of the piston cylinders are not proportional to the size of the press, resulting in a more compact overall design. And since fluid pressure amplification occurs inside the piston cylinder, the high pressure at which fluid needs to be pumped to the press may be reduced by up to two thirds, eliminating the need for the specially made high-pressure pumps, hoses, and fittings.

In designing the unitary cartridge with internal intensification, the inventor relied upon a hydraulic model based upon a standard hydraulic fluid used in the conventional tie-bar press's piston cylinder. In attempting to operate his new press, however, the inventor was surprised to discover that the standard hydraulic fluid used in the conventional press was not stiff enough for his new design, and the internal intensifier piston bottomed out without applying sufficient force on the cell. To overcome this obstacle, the inventor selected a water glycol based energy transmitting fluid, having a bulk modulus greater than 370,000 psi, such as that manufactured by Union Carbide, U.S. Pat. No. 4,855,070. To his surprise, in the press cartridge this fluid seemed to exhibit properties of stiffness greater than its constituent compounds as reported by its manufacturer, which resulted in an intensifier piston stroke even shorter than anticipated.

The inventor also discovered that because of the fluid's high stiffness, it stored less energy. This is significant because during the pressing cycle, the fluid is compressed within the cartridge and stores spring like energy. In the event of a catastrophic loss of pressure during the pressing cycle, known in the art as a “blow out,” this stored energy suddenly escapes creating tremendous torsional loads on the press components. Such loads are so great that they can actually render the press inoperable. Therefore, the less stored energy in the fluid, the less likely damage will result to the press from a blowout.

An additional objective of the inventor was to increase the volume of the reaction cell's payload. This he was able to achieve in the new unitary press design by use of a rectangular prismatic cell. Since the cartridges of the present invention are capable of functioning independently of each other, they are then capable of exerting differential forces on the sides of the cell while producing the uniform internal pressure required in the manufacturing process. This permits the use of a prismatic reaction cell. By utilizing a prismatically configured high-pressure chamber and rectangular reaction cell, the volume of the payload may be increased three fold. This increased volume translates into higher production rates and less cost per unit of product, hence greater efficiency and economy in the manufacturing process.

### SUMMARY OF THE INVENTION

In the art, superhard materials are manufactured by assembling the product to be produced inside a reaction cell, by placing the reaction cell in the high-pressure chamber of a high-pressure press, and by simultaneously compressing the cell to ultra high pressure while passing an electrical current through the cell's resistance heater mechanism, which raises the temperature inside the cell to above 1000° C. It is the object of this invention to utilize known reaction cell technology in an innovative press in order to produce superhard materials economically and efficiently. This will be achieved in the present invention by utilizing an innovative reduced mass unitary press frame and unitary cartridge bodies having an internal fluid pressure intensifier in combination with an internal mechanical intensifier. Each cartridge body has at least two fluid chambers open to the front and rear of the cartridge that are joined by an axial bore. The rear chamber is closed off by a high-pressure plug and contains a stepped cylindrical fluid intensifier that has a major surface with a circumferential seal means and a minor surface with accompanying circumferential seal means. The minor surface extends into the axial bore and encloses a volume of high-pressure fluid between its surface and the major surface with seal means of an anvil piston positioned within the front fluid chamber. The anvil piston is generally a truncated cone, and its truncated working surface protrudes from the front fluid chamber. When four or more of the cartridges are fixed into an ultra-high press frame, the convergence of the working surfaces of the respective anvil pistons cooperate to form the high pressure chamber of the press.

### BRIEF DESCRIPTIONS OF DRAWINGS

FIG. 1. An isometric view of a unitary cubic frame, a preferred embodiment of the press apparatus of the present invention.

FIG. 2. An isometric view of a preferred embodiment of the unitary cartridge of the press apparatus of the present invention.

FIG. 3. An isometric view of a preferred embodiment assembled press apparatus of the present invention.

FIG. 4. An exploded view of a preferred embodiment press apparatus of the present invention.

FIG. 5. An isometric view of a preferred embodiment unitary prismatic frame of the press apparatus of the present invention.

FIG. 6. An isometric view of a preferred embodiment spherical frame of the press apparatus of the present invention.

FIG. 7. A longitudinally sectioned view of a preferred embodiment unitary cartridge of the press apparatus of the present invention.

FIG. 8. A vertically sectioned view of a preferred embodiment unitary cubic frame of the press apparatus of the present invention, also depicting a perspective view of the working end of the cartridge.

FIG. 9. A vertically sectioned view of a preferred embodiment of the press apparatus of the present invention.

FIG. 10. A longitudinally sectioned view of a preferred embodiment cartridge of the press apparatus of the present invention comprising a plurality of internal fluid intensifier pistons.

FIG. 11. A perspective view of a preferred embodiment of the anvil/piston of the press apparatus of the present invention comprising a square anvil face for use in a cubic press.

FIG. 12. A perspective view of a preferred embodiment of the anvil/piston of the press apparatus of the present invention comprising a rectangular anvil face for use in a prismatic press.

FIG. 13. A perspective view of a preferred embodiment of the anvil/piston of the press apparatus of the present invention comprising a polygonal anvil face for use in a prismatic cubic press.

FIG. 14. A perspective view of a conventional tie-bar frame press.

### DETAILED DESCRIPTION

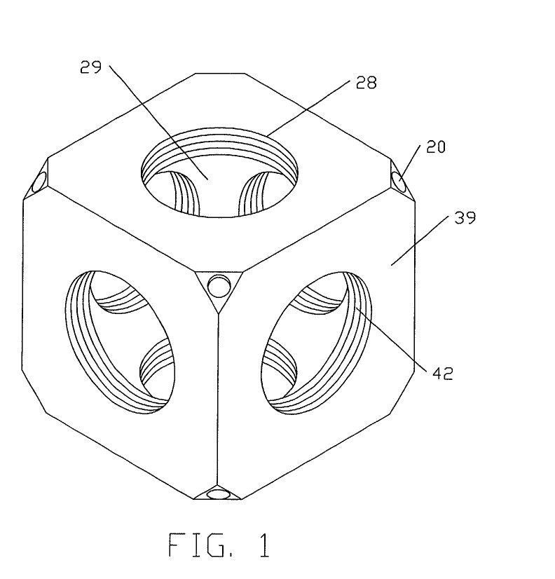

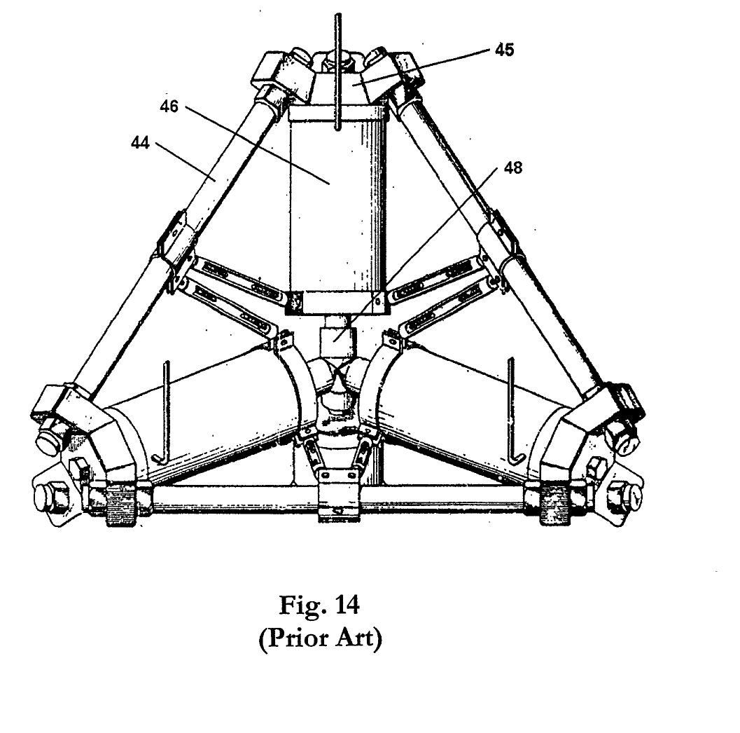

The present invention will be more fully described in reference to the embodiments depicted in FIGS. 1 through 18.

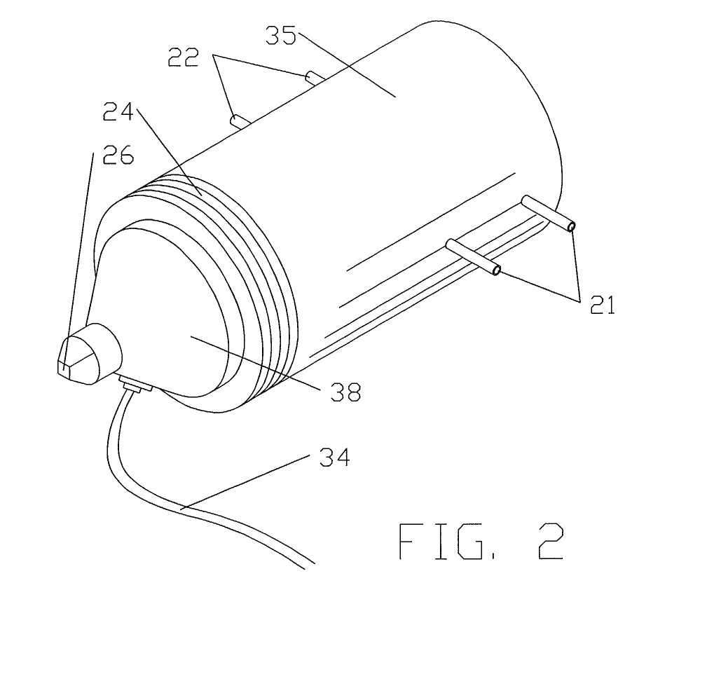

FIG. 1. The unitary cubic frame (39) of the press of the present invention is shown in perspective. The frame may be constructed of high strength steel such as AISI 4340 steel, or equivalent, polymer fibers such as Dupont's Kevlar, or graphite fiber composites capable of withstanding the high tensile stresses of normal press reaction pressures above 35 kilobars. The frame (39) comprises intersecting boreholes (28) with means of attachment to the cartridges (35), depicted in FIG. 2. In this embodiment, threads (42) comprise the means of attachment. Although not depicted, other means of attachment may comprise taper, friction, breech, and or bolts. Ports (20) are provided to allow access to the inside of the frame once the press is completely assembled. The cavity (29) resulting from the intersection of the bore holes (28) contains the high-pressure chamber of the working press.

FIG. 2. The cylindrical unitary cartridge (35) with internal intensification is depicted in perspective. The cartridge (35) comprises a unitary cylindrical body with means of attachment. In this embodiment, threads (24) comprise the means of attachment to the mating threads of the press frame. When attached to the frame, the frame and cartridge act cooperatively to produce ultra-high reaction pressures in excess of 35 kilobars. Although not depicted, other means of attachment may include taper, friction, breech, and or bolts. A truncated anvil/piston (38) protrudes from front or the working end of the cartridge. A conductor means (34) of passing an electrical current through the anvil/piston (38) is provided. Pressurized fluid is admitted into the cartridge (35) through inlets (21) and exhausted through outlets (22). In normal operation, the anvil/piston reciprocates rectilinearly. The synchronized advance of the anvil/pistons (26) toward the center of the press cavity (29) encloses and defines the high-pressure chamber of the press. When attached to the unitary frame (FIGS. 1, 5, and 6) the cartridge becomes an integral member of the press of the present invention.

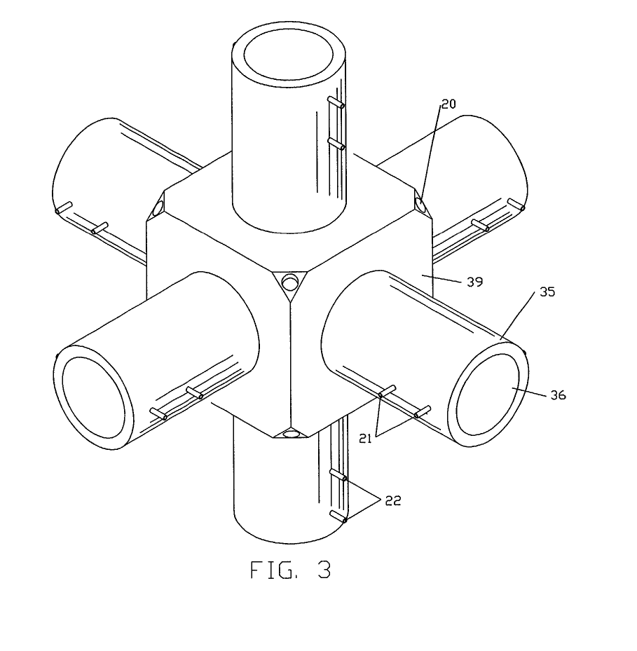

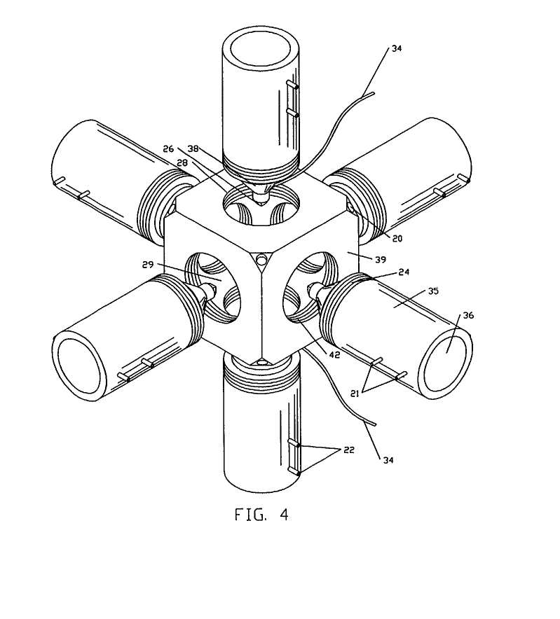

Referring to FIGS. 3 and 4, the assembled cubic press is depicted in isometric and exploded views comprising the cubic frame (39) with the six unitary cartridges (35) threaded into the bore holes (28). The frame and cartridges act cooperatively to produce the reaction forces required in press operation. The press is provided with ports (20) to allow access to the press cavity (29) for loading and unloading and visual inspection of the reaction cell when the press is fully assembled. In normal press operation, a reaction cell known in the art is placed inside the cavity (29). The anvil/pistons (38) are hydraulically urged forward, the anvil faces (26) describing the high-pressure chamber and contacting the cell, forming high-pressure gaskets also known in the art, and compressing the cell with forces in excess of 35 kilobars. While the reaction cell is being subjected to ultra high pressure, a means (34), known in the art, is provided for passing an electrical current through the anvil/piston (38) and the reaction cell's resistance heating mechanism, also known in the art, raising the temperature of the product inside the cell to more than 1000 degrees centigrade.

The frame of the present invention may comprise other preferred geometric embodiments such as a prism, a sphere, or an ellipsoid. Although not depicted in this application, those knowledgeable in the art will recognize additional configurations not described herein, but, nevertheless, predicated by this application.

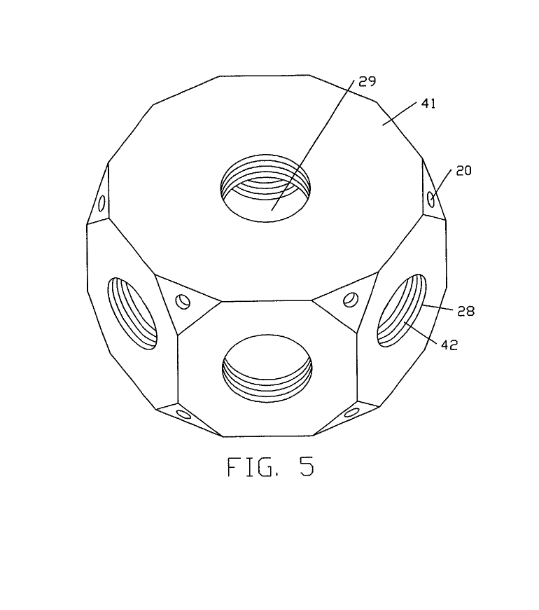

Referring to FIG. 5., The unitary prismatic frame of the present invention (41) is depicted in perspective comprising bore holes (28) with threads (42), and access ports (20). The frame may be constructed of hardened steel such as AISI 4340 steel, or equivalent, polymer fibers such as Dupont's Kevlar, or graphite fiber composites capable of withstanding the high tensile stresses of normal press operation above 35 kilobars. The frame (41) comprises intersecting boreholes (28) with means of attachment to the cartridges (35), depicted in FIG. 2. In this embodiment, threads (42) comprise the means of attachment. Although not depicted, other means of attachment may comprise taper, friction, breech, and or bolts. Ports (20) are provided to allow access to the inside the frame for visual inspection and loading and unloading the reaction cell, once the press is completely assembled. The cavity (29) resulting from the intersection of the bore holes (28) contains the high-pressure chamber of the working press. Although not shown in this preferred embodiment, a plurality of unitary cartridges may be attached to the prismatic frame (41) in a fashion similar to the cubic frame (39) depicted at FIG. 1.

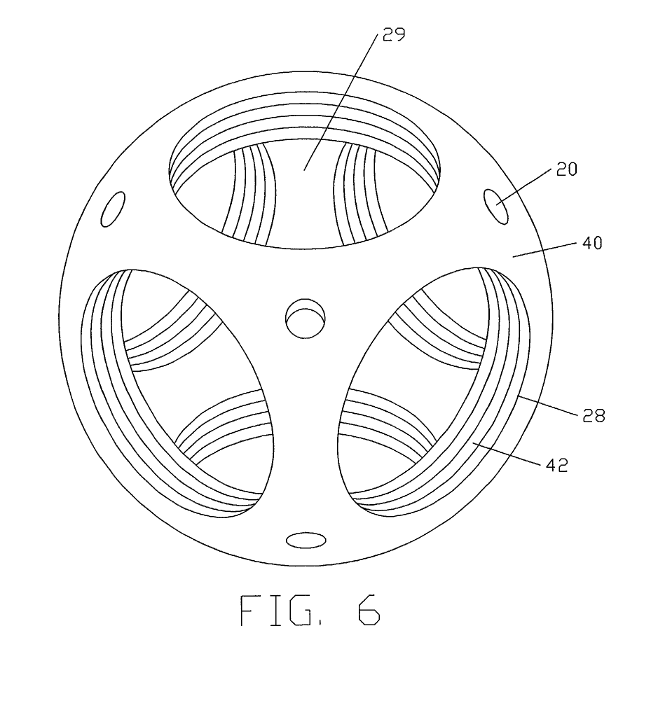

Referring to FIG. 6., an isometric view of a spherical frame (40) of the present invention is depicted. Like the cubic and prismatic frames, the unitary spherical frame of the present invention (40) comprises boreholes (28) with threads (42), and access ports (20). The frame may be constructed of hardened steel such as AISI 4340 steel, or equivalent, polymer fibers such as Dupont's Kevlar, or graphite fibers capable of withstanding the high tensile stresses and reaction forces of normal press operation above 35 kilobars. The frame (40) comprises intersecting boreholes (28) with means of attachment to the cartridges (35), depicted in FIG. 2. In this embodiment, threads (42) comprise the means of attachment. Although not depicted, other means of attachment may comprise taper, friction, breech, and or bolts. Ports (20) are provided to allow access to the inside of the frame for visual inspection and loading and unloading the reaction cell, once the press is completely assembled. The cavity (29) resulting from the intersection of the bore holes (28) contains the high-pressure chamber of the working press. Although not shown in this preferred embodiment, a plurality of unitary cartridges may be attached to the spherical frame (40) in a fashion similar to the cubic frame (39) depicted at FIG. 1.

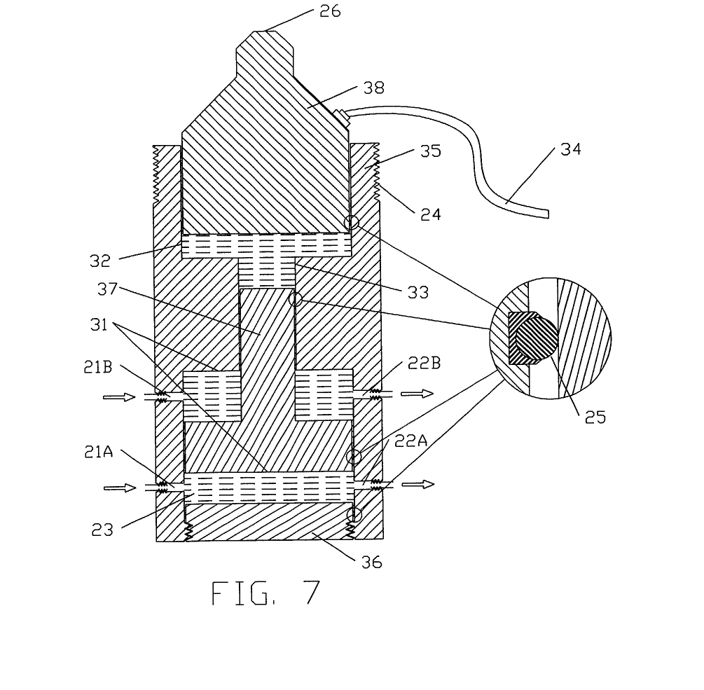

FIG. 7 depicts a longitudinal cross section of a unitary cartridge body with internal intensification. The cartridge body (35) comprises a first, or rear, pressure chamber (31), a second, or front, high-pressure chamber (32), and a connecting cylindrical passageway (33), or bore. The cartridge further comprises a pressurized fluid having a bulk modulus greater than 370,000 psi (23), pressure fluid inlets (21A and 21B), and pressure fluid outlets (22A and 22B), and a means of attachment (24), such as threads, taper, breech, and or bolts. Installed inside the first high pressure chamber (31) of the cartridge body (35) are a plug (36) and the stepped internal fluid intensifier piston (37), the minor surface, or minor diameter, of which is inserted into the cylindrical passageway (33). The truncated anvil/piston (38) is inserted into the front, or second, high-pressure chamber (32) in such a manner that the truncated surface protrudes from the front attachment end of the cartridge body. This is the working end of the cartridge and is attached to the borehole of the frame. When attached, the frame and the cartridge cooperatively produce the reaction pressures required in press operation. The anvil/piston (38), the intensifier piston (37), and the plug (36) further comprise a seal means (25).

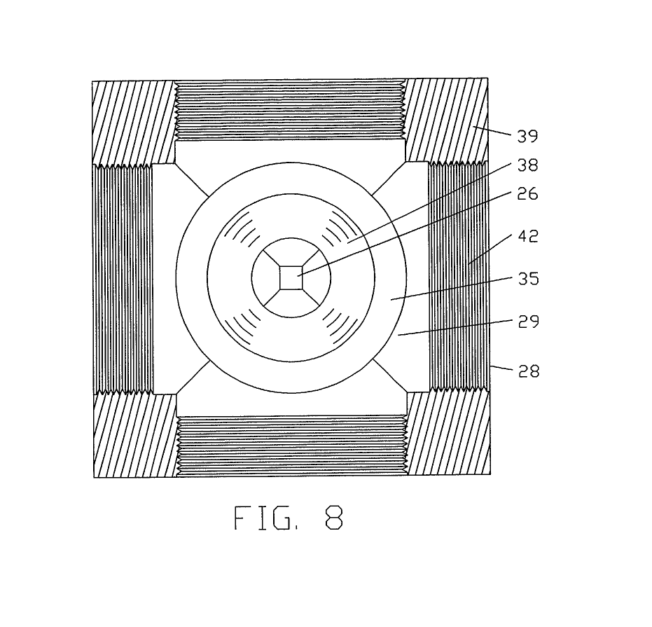

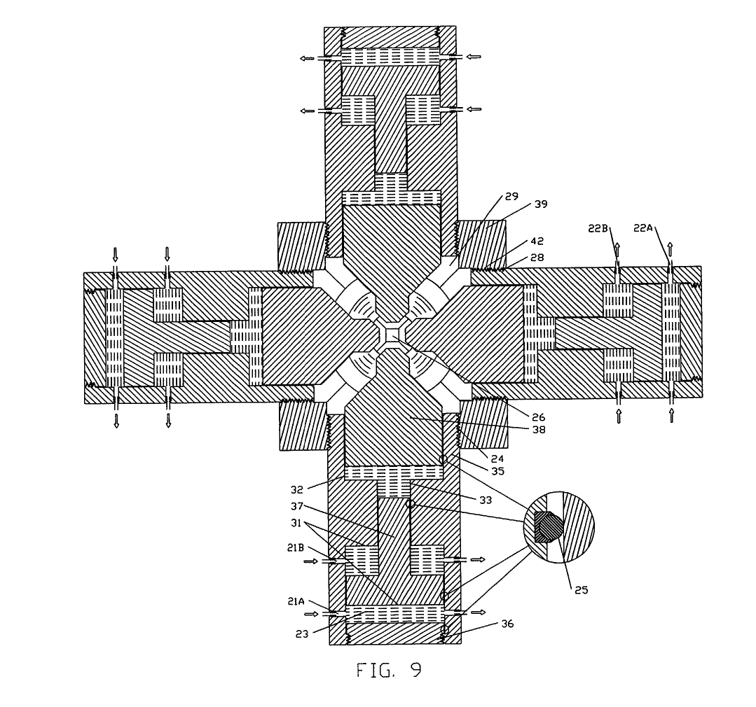

In normal operation of the press cycle, the pressurized fluid (23) from an external pumping source, not shown, is admitted into the rear pressure chamber (31) via the inlet (21A), forcing the internal fluid intensifier piston (37) forward. The forward motion of the piston (37) acts upon the fluid in the front high-pressure chamber (32) and urges the anvil/piston (38) forward. As anvil/piston (38), in cooperation with similarly configured opposed anvil pistons, comes in contact with a typical reaction vessel known in the art, not shown, the fluid pressure from the external pumping source is increased in the rear chamber (31) causing amplified fluid pressure to build in the front chamber (32), behind the anvil/piston (38). The anvil/piston (38) then acts as a mechanical intensifier of the pressurized fluid working on it, generating ultra high pressure at the anvil face (26). In the preferred embodiment press frames (FIGS. 1, 5, and 6), as the anvil faces (26) approach one another, (See FIG. 9), they describe a polyhedron which encloses the sides of the reaction vessel, which forms the press's high-pressure chamber. A means (34) of passing an electrical current through the anvil/piston (38) is provided. As the reaction cell is compressed by the anvils/pistons (38) working in concert, an electrical connection, known in the art, is achieved between the anvil face (26) and the reaction cell's resistance heating mechanism causing the temperature inside the cell to rise above 1000 degrees centigrade.

At the end of the press cycle, the pressurized fluid (23) acting on the intensifier piston (37) is evacuated through the outlet (22A). Additional pressurized fluid is then admitted into the pressure chamber 31 via inlet (21B) forcing the piston (37) to retract. As the piston (37) retracts, a vacuum is created in the front high-pressure chamber (32) behind the anvil/piston (38) causing it to retract also. At the start of the press cycle, the fluid in front of the intensifier piston is evacuated via outlet (22B).

For example, if you take a stepped fluid intensifier having a major surface area of about 113 sq. in. and a minor surface area of about 7 sq. in. and insert it into the rear fluid chamber so that the major surface is contained in the chamber and the minor surface area is contained in the bore, and you take a truncated anvil piston having a major surface area of about 113 sq. in. and a truncated surface area of about 2.25 sq. in. and place it into the front fluid chamber so that the major surface is contained in the chamber and the truncated surface protrudes from the front of the cylinder, and the space between the two pistons is completely filled with an entrapped fluid, and then you plug the end of the rear chamber and pressurize the rear chamber behind the piston's major surface to about 2200 PSI, the pressure in the front chamber will rise to about 35,000 PSI, and the pressure exerted by the anvil piston on a parallel surface of the reaction vessel will be at least 35 Kilobars. Those skilled in the art will recognize that by manipulating the dimensions of the components of the unitary cartridge, the pressures and the performance of the press may be configured to meet a variety of production needs.

Referring to FIG. 8, a vertical cross section of the unitary frame (39) is depicted, comprising a preferred embodiment frame (39), intersecting through bore holes (28), threads (42) as a means of attachment, and a cavity (29). A view of the working end of the cartridge (35) is also shown, comprising the anvil/piston (38) and the truncated anvil face (26). Not shown are other preferred embodiments of the attachment means such as taper, breech, friction, and or bolts.

Referring to FIG. 9, a longitudinal cross section of a preferred embodiment unitary cubic frame press of the present invention is depicted comprising a cubic frame (39), with a plurality of unitary cartridge bodies (35) attached. The unitary frame further comprises through boreholes (28), mating threads as a means of attachment (42), and a cavity (29) formed by the intersection of the through bore holes (28). Although the preferred embodiment prismatic frame press (FIG. 5) and the preferred embodiment spherical frame press (FIG. 6) are not shown in cross section, a plurality of unitary cartridges may be attached to them in a fashion similar to that depicted herein. The unitary cartridge bodies (35) further comprise a front pressure chamber (31), a rear high-pressure chamber (32), a cylindrical passageway (33), and a plug (36), installed in the end of the first pressure chamber (31). The cartridges further comprise the stepped internal fluid intensifier pistons (37) installed inside the first pressure chambers (31), with their minor diameters in the cylindrical passageways (33). The cartridges further comprise the truncated anvil/piston (38) installed in and protruding from the second high-pressure chamber (32), pressurized fluid (23), a seal means (25), mating threads as a means of attachment (24), a plurality of fluid inlets (21A and 21B), and a plurality of fluid outlets (22A and 22B.

Referring to FIG. 10. A cross section of a preferred embodiment unitary cartridge body is depicted having a plurality of internal intensifier pistons. The cartridge comprises a plurality of high-pressure chambers (31), a plurality of passageways (33), a plurality of internal fluid intensifier pistons (37), a plurality of fluid inlets (21A and 21B), a plurality of fluid outlets (22A and 22B), and such other features as described in FIGS. 7 and 9.

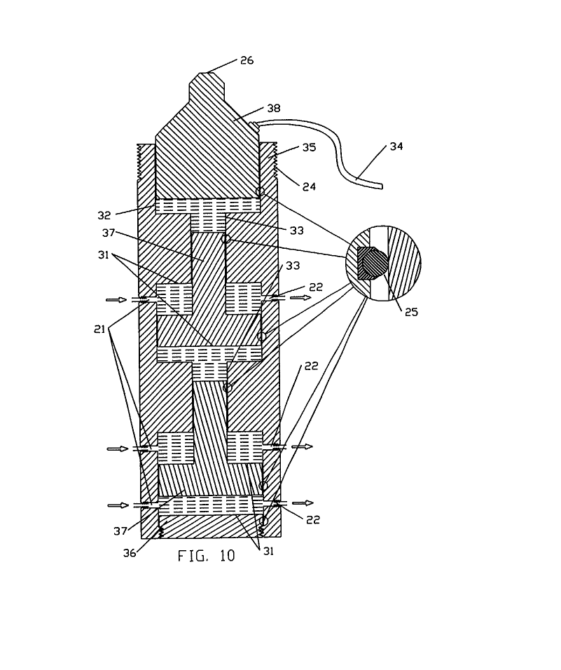

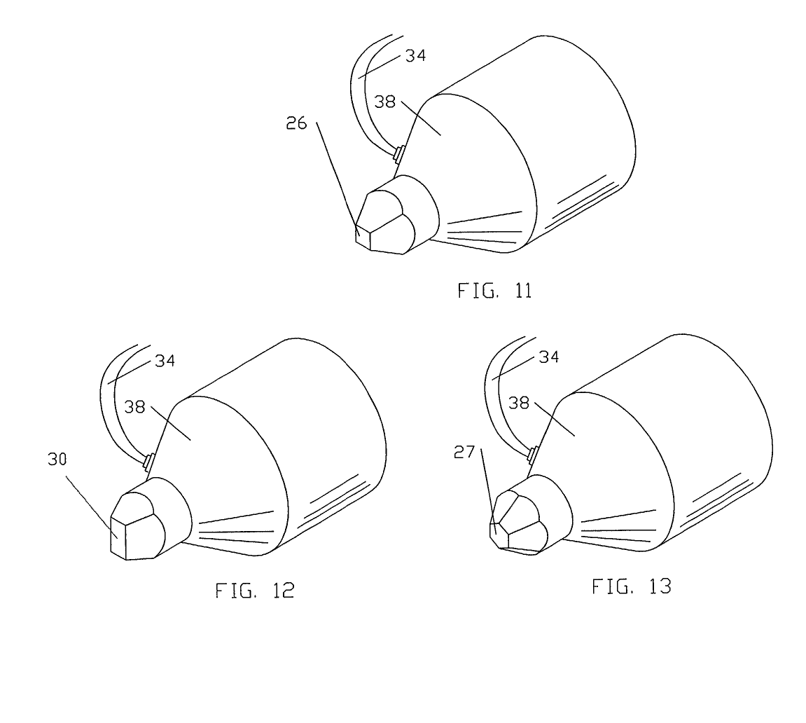

Referring to FIGS. 11, 12, and 13. The anvil/pistons (38) comprise a means of electrical connection (34). FIG. 11 comprises an anvil/piston with a truncated face (26) describing a plane square. FIG. 12 comprises an anvil/piston with a truncated face (30) describing a plane rectangle. And FIG. 13 comprises an anvil/piston with a truncated face (27) describing a plane polygon. Typically, anvils are composed of materials having the highest compressive strengths such as cemented metal carbides. The anvil faces enclose parallel sides of the reaction vessel and form the press's high-pressure chamber.

I claim:

1. An ultra-high pressure cylindrical unitary cartridge body with internal fluid intensification and mechanical intensification, comprising:
a plurality of external circumferential threads proximate the forward end of said unitary cartridge for attachment of said unitary cartridge to a press frame having mating threads, so that when joined the cartridge and frame act cooperatively to produce ultra-high reaction pressures;
a plurality of axial fluid chambers connected by one or more axial bores, said chambers and bores being integral with said cartridge body, and the front and rear chambers being open ended;
a plurality of inlet and outlet ports for admitting fluid into, and evacuating fluid from, the rear fluid chamber;
a high pressure plug enclosing the rear fluid chamber;
a stepped, cylindrical fluid intensifier piston having a major surface with seal means and a minor surface with seal means, and the piston being positioned within said rear chamber with its minor surface extending into said axial bore;
a generally conical intensifier anvil piston having a major surface with seal means and a truncated minor surface, and said piston being positioned within said front fluid chamber having its major surface within said front chamber and its minor surface protruding from the forward end of said cartridge body and said anvil piston being provided with a means for connection to an external source of electrical power;
a fluid sealed within the front chamber in contact with minor surface of the intensifier piston and the major surface of the anvil piston; and
a fluid pressurized by an external source, wherein said pressurized fluid is admitted into said rear chamber by way of said inlet ports and contacting the rear portion of the major surface of the intensifier piston and urging it forward into the axial bore in such a manner so as to pressurize the fluid sealed within the front chamber, and thereby urging the anvil piston forward until its truncated surface contacts a parallel surface of an ultra-high pressure reaction vessel cooperatively with other similarly configured opposing anvil pistons, whereupon the pressure within the forward chamber is allowed to rise sufficiently to achieve at least 35 kilobars of pressure on all parallel surfaces of said reaction vessel, and, thereafter, said fluid being evacuated from said rear chamber through said outlet ports while pressurized fluid is admitted in front of the major surface of the fluid intensifier in such a manner so as to force said fluid intensifier and anvil piston to retract to their original position.

2. The unitary cartridge body of claim 1, using a fluid having a bulk modulus in excess of 370,000 psi.

3. The unitary cartridge body of claim 1, being attached to a unitary frame capable of producing reaction pressures in excess of 35 Kilobars.
